(19) United States
(12) Patent Application Publication
(10) Pub. No.: US 2025/0113775 A1
(43) Pub. Date: Apr. 10, 2025

(54) TWO-PIECE HARVESTER

(71) Applicant: ORCHARD-RITE LTD., INC., Union Gap, WA (US)

(72) Inventors: Dax Brock Wells, Yakima, WA (US); Kent Allen Hebdon, Yakima, WA (US); Colt Cannon Warren, Mesa, WA (US)

(21) Appl. No.: 18/905,799

(22) Filed: Oct. 3, 2024

Related U.S. Application Data
(60) Provisional application No. 63/542,433, filed on Oct. 4, 2023.

(51) Int. Cl. A01D 46/26

(52) U.S. Cl. CPC A01D 46/26; A01D 2046/262

(57) ABSTRACT

Systems, device, and methods for harvesting fruits or nuts are disclosed. A two-piece harvester is disclosed that mitigates dust associated with harvesting fruits and nuts. The two-piece harvester may include a shaker configured to shake a tree and cause the fruits or nuts to fall and a receiver configured to collect the fallen fruits or nuts and deposit the fruits or nuts on the ground. The shaker may be configured to couple with trees having a low crotch height, and may include a blower to direct material off of the shaker and onto the receiver. The receiver may include a hopper configured to receive fruits or nuts from a conveyor and control a rate of deposition of the fruits or nuts onto the ground. The receiver may include a windrowing device configured to prepare the ground prior to creation of a windrow and control a size of a windrow.

### PRIORITY INFORMATION

The present Application for Patent claims priority under 35 U.S.C. § 119 to U.S. Provisional Patent Application No. 63/542,433, by Wells et al., filed Oct. 4, 2023 and entitled “Two-Piece Harvester,” which is assigned to the assignee hereof, and hereby expressly incorporated by reference herein.

### BACKGROUND

The following relates generally to a two-piece harvester, and more specifically to a two-piece harvester having a shaker and a receiver for harvesting tree fruits or tree nuts.

Some nuts and fruit (e.g., almonds, pistachios, macadamias, olives, cherries, prunes, or other tree crops) may be harvested using various methods. After harvesting, some of these nuts and/or fruit may be deposited on the ground and allowed to dry for several days in the sun before they are picked up, shelled, and packaged for sale. Harvesters may be designed to increase related harvesting yields, reduce damage to the crop while harvesting, and ease to those assisting with such actions.

### SUMMARY

The described techniques relate to improved systems, devices, or apparatuses for harvesters, and more specifically for two-piece harvesters. Generally, the described systems, devices, apparatuses, or methods are configured to harvest fruits or nuts. A two-piece harvester is disclosed that may mitigate damage to fruits or nuts that may occur during the process of harvesting including after the fruits or nuts are deposited on the ground. The two-piece harvester may reduce dust associated with harvesting fruits and nuts. The two-piece harvester may include a shaker configured to shake a tree and cause the fruits or nuts of the tree to fall, and a receiver configured to receive and collect the fallen fruits or nuts and deposit the fruits or nuts on the ground or in bins. The shaker may also include deflectors to deliver fruits or nuts to the receiver side. The shaker may be configured to couple with trees with a low crotch height (e.g., less than 25 inches). The receiver may include a hopper that is configured to control a rate of deposition of fruits or nuts. The receiver may include a windrowing device that is configured to prepare the ground prior to formation of a windrow and to control a size (e.g., height and width) of a windrow.

### BRIEF DESCRIPTION OF THE DRAWINGS

FIG. 1 illustrates an example of a perspective view of a two-piece harvester for harvesting tree fruit or tree nuts having a shaker side and a receiver side in accordance with aspects of the present disclosure.

FIGS. 2A and 2B illustrate examples of diagrams of multi-unit harvesting techniques for a harvesting area in accordance with aspects of the present disclosure.

FIG. 3 illustrates an example of a perspective view of a shaker side of a harvester in accordance with aspects of the present disclosure.

FIG. 4 illustrates an example of an exploded diagram of a shaker side of a harvester in accordance with aspects of the present disclosure.

FIG. 5 illustrates an example of a perspective view diagram of a receiver side of a harvester in accordance with aspects of the present disclosure.

FIG. 6 illustrates an example top view diagram of a shaker side of a harvester in accordance with aspects of the present disclosure.

FIG. 7 illustrates an example side view diagram of a shaker side of a harvester in accordance with aspects of the present disclosure.

FIG. 8 illustrates an example isometric view diagram of a receiver side of a harvester that includes a hopper and windrowing device in accordance with aspects of the present disclosure.

FIG. 9 illustrates an example side view diagram of a receiver side of a harvester that includes a hopper and windrowing device in accordance with aspects of the present disclosure.

FIG. 10 illustrates an example top view diagram of a receiver side of a harvester that includes a hopper and windrowing device in accordance with aspects of the present disclosure.

FIGS. 11A and 11B illustrates example top and isometric view diagrams of a windrowing device in accordance with aspects of the present disclosure.

FIG. 12 illustrates an example perspective view of a shaker side of a harvester coupled with a tree in accordance with aspects of the present disclosure.

FIG. 13 illustrates an example isometric view of receiver side of a harvester that includes a hopper and windrowing device in accordance with aspects of the present disclosure.

### DETAILED DESCRIPTION

Systems, devices, and methods for harvesting fruits or nuts are disclosed. Some fruits or nuts, such as almonds, grow on trees. After being harvested, but before being processed, some fruits or nuts, such as almonds, may be allowed to dry in the sun on the orchard floor to properly allow drying and facilitate later aspects of the harvesting process. For example, current methods for harvesting almonds may include: 1) a tree shaker that shakes the tree to shake the almonds off of the tree and onto the ground; 2) a sweeper that sweeps the almonds, debris, and dirt into a windrow in between two rows of trees; 3) a conditioner that picks up the windrow and separates debris and dirt from the almonds and then lays a clean windrow back down for drying; 4) a drying process that allows the almonds to air and sun dry until the moisture content reduces to an acceptable level for factory processing; and 5) a harvester that picks up the dried almond windrow to haul the almonds out of the orchard. Current methods for harvesting almonds, and particularly the sweeper and conditioner processes, may result in large quantities of dust being disturbed and released into the air. Government and local regulations may push for reduction of dust released by the almond harvesting process. For example, California may push for a 50% reduction in dust associated with almond harvesting.

Additionally, some trees, such as almond trees, may have low crotch heights. A crotch height refers to the height of the lowest branch that extends from the trunk of a tree. The crotch height of pecan trees or pistachio trees, for example, may be 35 inches or higher from the ground, while the crotch height of almond trees may be 20 to 25 inches from the ground. A shaker engages a trunk of a tree below the lowest branch, and therefore shakers used with almond trees may be configured to engage the trunk of the tree at 25 inches or less from the ground.

A two-piece harvester is disclosed that reduces the amount of dust released into the air that is associated with harvesting of fruits or nuts, and particularly almonds. The two-piece harvester disclosed may eliminate the sweeper and conditioner steps, which may be associated with the release of large quantities of dust. The two-piece harvester may include a shaker configured to shake a tree and cause the crops (e.g., fruits or nuts) to fall and a receiver configured to collect the fallen crops (e.g., fruits or nuts) and deposit the crops into a windrow on the ground. For example, the shaker and receiver may each include deflectors that direct fallen crops onto a conveyor. The shaker may include one or more blowers that provide forced air that moves the crops from a deflector positioned over a shaker head onto the conveyor. The receiver may include a hopper at an end of the conveyor that may be configured to deposit the crops, such as fruits or nuts, into a windrow. The hopper may control a rate of deposition of the crops onto the ground in order to control the size of the windrow. The receiver may include a windrowing device than controls the size (e.g., height and width) of the windrow and prepares the ground prior to deposition of the crops via removing debris and/or flattening the ground.

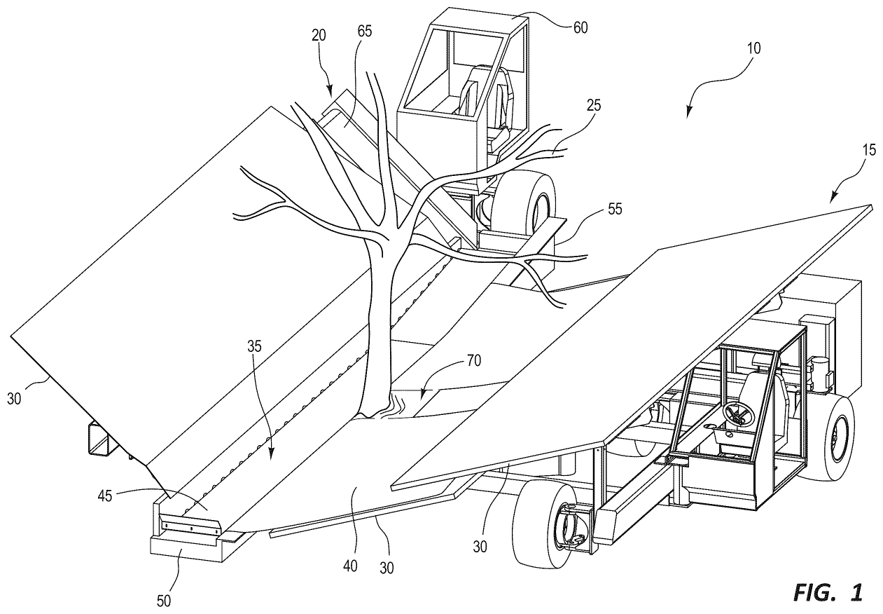

FIG. 1 illustrates an example of a system 10 for harvesting tree nuts or tree fruit such as almonds in accordance with aspects of the present disclosure. The system 10 may be an example of a two-piece harvester. The system 10 may include a shaker 15 configured to shake a tree and a receiver 20 configured to collect objects (e.g., fruits or nuts) that fall from the shaken tree and to then deposit the fallen objects. In some cases, the shaker 15 may be referred to as a shaker side of a two-piece harvester and the receiver may be referred to as a receiver side of the two-piece harvester.

Some nuts and fruit (e.g., almonds, pistachios, macadamias, olives, cherries, prunes, or other crops) may be harvested using the system 10. The shaker 15 may be configured to grasp a tree 25 and mechanically shake the tree 25 to cause fruits or nuts in the tree to fall. The shaker 15 may include a shaker head that includes jaws or pincers that clamp onto a portion of the tree 25 (e.g., the trunk of a tree). A mechanical motor coupled with the pincers may be configured to cause the tree 25 to shake after the pincers are clamped onto the tree 25.

The system 10 may be configured to collect the fruits or nuts falling from the tree 25 without causing them to be damaged. A shaker 15 may be positioned on a first side of the tree 25 and the receiver 20 may be positioned on a second side of the tree 25. The shaker 15 and the receiver 20 may include one or more deflectors 30 configured to intercept the falling fruits or nuts before they reach the ground and direct the fruits or nuts (e.g., to a conveyor 35 of the receiver 20). As shown, the deflectors 30 may be slanted with respect to the ground in order to direct, via gravity, the fruits and nuts onto a conveyor of the receiver 20. In some cases, a covering 40 (e.g., such as a tarp, cloth, or other component to soften the force the falling crops experience) may be positioned over the deflectors 30 to further protect the falling nuts or fruit. As described herein, the shaker 15 may be configured to clamp onto a tree with a low crotch height. For example, the shaker 15 may be configured to clamp onto a tree with a crotch height of less than 25 inches from the ground. Accordingly, the lower deflector 30 of the shaker side may include a notch 70 to receive the tree where the shaker clamps onto the tree. In order to catch nuts or fruit that fall above the notch 70, a deflector that is less slanted or flat with respect to the ground may cover the notch 70, and the shaker 15 may include blowers to blow air to direct the fruits or nuts off the deflector that is less slanted or flat with respect to the ground and onto the conveyor.

The conveyor 35 of the receiver 20 may be configured to convey the fruits or nuts to a hopper which may deposit the nuts or fruit in a desired location such as a ground surface, a bin, or a towable device. In some examples, the receiver may include a windrowing device which receives the fruits or nuts from the hopper and organizes the fruits or nuts into a windrow on the ground. The conveyor 35 may include one or more motors, rollers, and/or belts to move the fruits or nuts. The conveyor 35 may include one or more portions. A first portion 45 may move nuts from a first end 50 of the receiver 20 toward a second end 55 of the receiver 20 that is associated with the cab 60. A second portion 65 may move nuts from the first portion 45 to a hopper that deposits the fruits or nuts on the ground or in a bin. In some aspects, the receiver 20 may include a blower which blows air at the end of the second portion in order to remove debris such as leaves from the fruits or nuts before the fruits or nuts are deposited into the hopper. In some cases, the hopper may be configured to deposit the fruits or nuts in different places based on the direction of travel of the receiver.

Some fruits or nuts may be allowed to dry before hulling and/or shelling occurs. For example, almonds may be allowed to dry in the sun for extended periods (e.g., several days or weeks) to ensure that the moisture content of the almond is correct for hulling and/or shelling. The receiver 20 may be configured to deposit the fruits or nuts (e.g., almonds) on the ground in a windrow. A windrow may be a row of a harvested crop (e.g., almonds) that is allowed to dry before being processed further (e.g., hulled, shelled, combined, baled, or rolled). To prevent damage to the harvested crop in a windrow, to the trees in the orchard, or other damage that may occur to equipment, crops, or land, the shaker 15 and/or the receiver 20 may include a moveable cab. The cabs may be moveable to increase the visibility of the operator during different types of operations. For example, with the moveable cabs, the operator may be able to see the tree and/or any windrows of crop on the ground. To allow for the elimination of the high dust creation sweeping and conditioning steps, the receiver may include a ground preparation device that may prepare the ground via removal of debris and flattening of the ground and may lay down a windrow based on the direction of travel of the receiver. The ground preparation device may receive the fruits or nuts (e.g., the almonds) from the hopper.

After the crop has dried sufficiently, a pick-up machine may collect the crop in the windrows and transport the crop to other processing facilities. For example, for almonds, a pick-up machine may transport the almonds to a huller/sheller facility. The almonds may be prepared hulled and/or shelled at such a facility and in other ways prepared for sale.

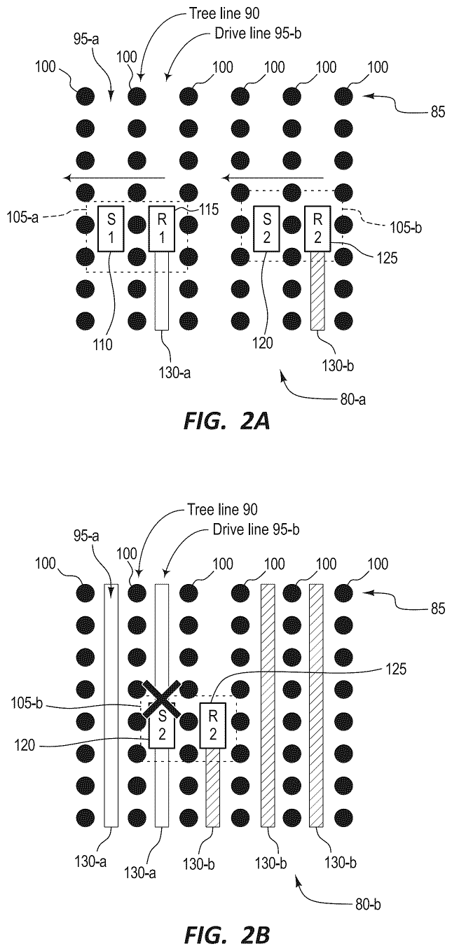

FIGS. 2A and 2B illustrate examples of diagrams 80 of multi-unit harvesting techniques for an orchard 85 in accordance with aspects of the present disclosure. The orchard 85, as one example of a harvesting area, may include a plurality of tree lines 90 and a plurality of drive lines 95. A tree line 90 may include a plurality of trees 100 that grow fruits or nuts. A drive line 95 may be configured to allow equipment such as harvesters, shakers, receivers, pick-up machines, or combinations thereof, to access individual trees 100 of the orchard 85.

Diagram 80-a of FIG. 2A illustrates a technique for harvesting the orchard 85 that includes multiple harvesting units 105 operating concurrently. A first harvesting unit 105-a operating in the orchard 85 may include a first shaker 110 and a first receiver 115. The first shaker 110 may be an example of the shaker 15 described with reference to FIG. 1, and the first receiver 115 may be an example of the receiver 20 described with reference to FIG. 1. When harvesting a plurality of trees 100 in a tree line 90, the first shaker 110 may travel along a first drive line 95-a positioned on a first side of the tree line 90 and a first receiver 115 may travel along a second drive line 95-b on a second side of the tree line 90 (e.g., which may be opposite the first side).

When harvesting a fruit or nut of a tree 25, both the first shaker 110 and the first receiver 115 may be positioned next to the same tree 25. The first shaker 110 may shake the tree 100 and the first shaker 110 and/or the first receiver 115 may collect the falling fruits or nuts into a conveyor (e.g., a conveyor of the first receiver 115). In some cases, the first receiver 115 may deposit the fruits or nuts in a windrow 130-a in the drive line 95-b. The first receiver 115 may be configured to form the windrow 130-a behind the first receiver 115 opposite the direction of travel of the first receiver 115. For example, the first receiver 115 may include a hopper and a windrowing device that control the size of the windrow 130-a.

As the orchard 85 is harvested, the first harvesting unit 105-a may move from tree line 90 to tree line 90. Concurrently, a second harvesting unit 105-b that may include a second shaker 120 and a second receiver 125 may be harvesting another portion of the orchard 85. The second harvesting unit 105-b may deposit its own windrow 130-b in the various drive lines 95.

Diagram 80-b of FIG. 2B illustrates that using such a multi-harvesting unit technique for the orchard 85 will lead to a situation where the second shaker 120 or the second receiver 125 of a second harvesting unit 105-b may travel along a drive line 95 that includes a windrow 130 of crops deposited on the ground. For example, diagram 80-b shows that the second shaker 120 of the second harvesting unit 105-b may travel down the drive line 95-b that already includes a windrow 130-a deposited by the first harvesting unit 105-a.

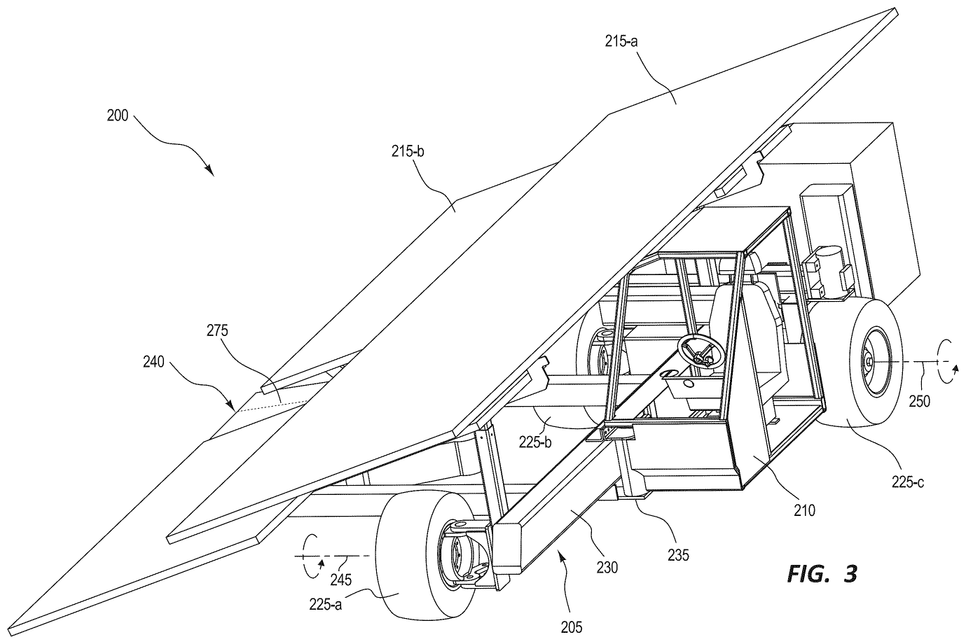

Shakers 15 and receivers 20 are described herein for preventing the loss of crops during the process of harvesting. For example, a shaker 15 and/or a receiver 20 may include moveable cabs to allow operators better vision and control during a harvesting procedure. Further, the moveable cabs may be configured to better allow the shaker 15 and the receiver 20 to move bidirectionally along a drive line 95. A shaker 15 may also include an extendible wheel. In some examples, the wheel may not be extendible (e.g., may be fixed on the axis of rotation). A receiver 20 may be configured with a hopper that may be configured to selectively deposit the crop in the windrow 130 in different locations based on the direction of travel of the receiver 20. Additional details about these features are described with reference to FIGS. 3-13, among other sections.

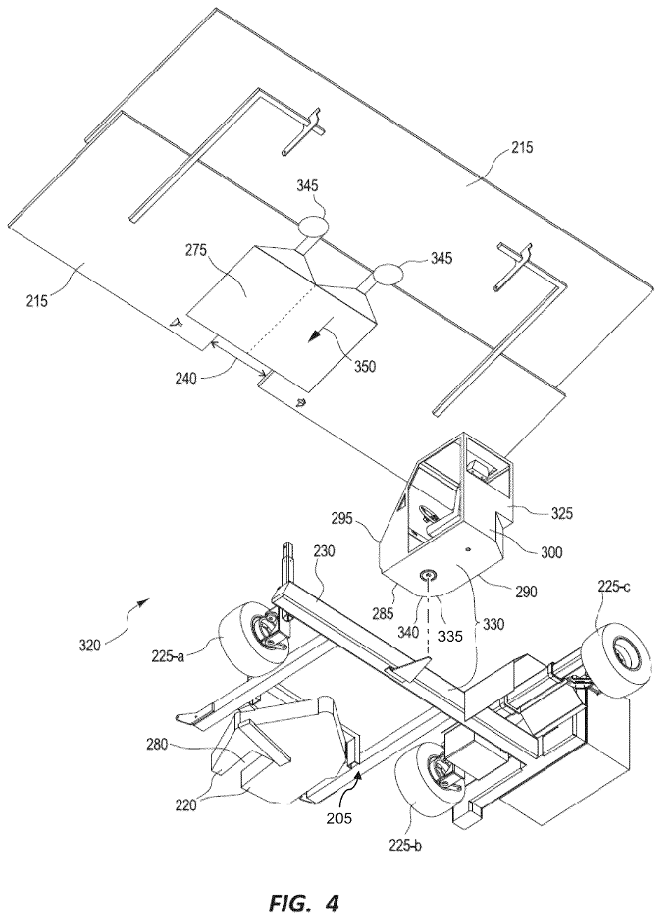

FIG. 3 illustrates an example of a shaker 200 for harvesting tree nuts or tree fruit such as almonds in accordance with aspects of the present disclosure. The shaker 200 may be an example of the shaker 15 described with reference to FIG. 1. The shaker 200 may be configured to couple with a trunk of a tree and shake the tree so that fruits or nuts fall out of the tree. The shaker 200 may include a frame 205, cab 210, one or more slanted deflectors 215, one or more flat deflectors 275, a shaker head 220 (not shown in FIG. 3, shown in FIG. 4), and a plurality of wheels 225.

The frame 205 may be a supporting structure of the shaker 200. The frame 205 may be configured to support components of the shaker 200 and to deal with static and dynamic loads, without undue deflection or distortion. The frame 205 may include one or more beams or rails. For example, a central beam 230 may extend between an axis of rotation of a front wheel 225-a and an axis of rotation of the plurality of rear wheels 225-b, 225-c.

The cab 210 may be coupled with the central beam 230 of the frame 205 using a coupling component 235. The coupling component 235 may be configured such that the cab 210 is rotatable relative to the frame 205. The cab 210 may be moveable between a first position (e.g., a position parallel to a first direction of travel of the shaker 200 (shown in FIG. 3)) and a second position (e.g., a position perpendicular to the first direction of travel of the shaker 200). In some cases, the cab 210 may be positionable in more positions than the first position or the second position. For example, the cab 210 may be configured to slide along the central beam 230 in some cases. The cab 210 may be positionable in a variety of different rotations and/or rotation angles relative to the frame 205, including one or more positions between or at set or variable positions between a first position (e.g., a position parallel to a first direction of travel of the shaker 200 (shown in FIG. 3)) and a second position (e.g., a position perpendicular to the first direction of travel of the shaker 200). In some cases, the cab 210 may be fixed relative to the frame (e.g., may not be positionable in a variety of different rotations and/or rotation angles relative to the frame 205).

The one or more deflectors 215 of the shaker 200 may be configured to deflect falling objects (e.g., nuts, almonds) into a conveyer of a receiver. The deflectors 215 may be examples of the deflectors 30 described with reference to FIG. 1. The shaker 200 may include any number of deflectors 215 (e.g., one, two, three, four, five, six, seven, eight). In the illustrative example, the shaker 200 may include two deflectors, an upper deflector and a lower deflector. The deflectors 215 may be repositionable in some cases to provide distinct advantages. For example, the upper deflector 215-a may be configured to move up-and-down. The lower deflector 215-b may be configured to move up-and-down or laterally away from or toward the cab 210. The lower deflector 215-b may include a notch 240 sized to receive a tree and/or allow the shaker head 220 to operate and grasp the tree. A deflector 275 that is less slanted with respect to the deflectors 215 or is flat with respect to the ground may cover the notch 240. In some examples, the deflector 275 may include a slit for receiving a trunk of the tree. The shaker 200 may include one or more blowers that blow air to direct the fruits or nuts off on the deflector 275 onto a conveyor of a receiver. These configurations and related operations will lead to increased efficiencies and overall efficacy in harvesting. The deflectors 215 may be sized to extend beyond the dimensions of the canopy of the tree, at least the canopy of a first side of the tree. The deflectors 215 may be configured to be positionable based on the canopy of the tree being harvested.

The shaker head 220 may be configured to grasp and shake a tree. The shaker head 220 may be configured to move in a variety of different directions to grasp the tree. For example, the jaws or pincers, among other potential example components, may be configured to move away from or toward the cab 210. When the shaker 200 prepares to shake a tree, the operator may move shaker head 220 of the shaker to align with the tree. Once the jaws or pincers are aligned, the operator may move the open shaker head 220 away from the cab 210 such that the pincers of the shaker head 220 surround the tree. The shaker head 220 may include one or more moveable pincers configured to receive and squeeze an object between them (e.g., a trunk of a tree). In some cases, the jaws may be configured to be moveable in one or more directions (e.g., a front-to-back direction or a side-to-side direction or a combination). Such movement may allow the jaws to improve alignment with the tree without moving the entire shaker 200. The shaker head 220 may be configured to shake or vibrate the tree once the shaker head 220 has grasped the tree.

The shaker 200 may include a plurality of wheels 225 in some cases. In the illustrative example, the shaker 200 includes three wheels, a first wheel 225-a rotating on a first axis of rotation 245 and a second wheel 225-b and a third wheel 225-c rotating along a second axis of rotation 250. In some cases, the third wheel 225-c may be selectively extendible. In some cases, the third wheel 225-c may be fixed with respect to the second wheel 225-b. The wheels 225 may be coupled to the frame 205 using a plurality of components and/or linkages to allow each wheel to be controlled independently.

Each of the wheels 225 may be independently steerable, meaning that the turning angle of each wheel 225 and/or the direction of travel of each wheel may be independently controlled. By having independent control of each wheel, the shaker 200 may be configured to operate using a plurality of steering modes. A steering mode may indicate a configuration of each wheel 225. A steering mode may indicate a turning angle of a wheel 225, whether a wheel is configured to change its turning angle or whether the turning angle is fixed, whether the turning angle of the wheel is tied to the turning angle of another wheel, a direction of rotation of wheel, whether the direction of rotation of the wheel is tied to the direction of rotation of another wheel, or a combination thereof. In some examples, the wheels on one axis of rotation may be steerable (e.g., either the first wheel 225-a or the second wheel 225-b and the third wheel 225-c).

An example of steering modes may be a forward-wheel steer mode where the wheel(s) farthest forward relative to the direction of travel are configured to turn and steer the vehicle and the wheels farther back relative to the direction of travel are not configured to turn (e.g., have a fixed turning angle). Most vehicles used by consumers use a forward-wheel steer mode. Another example of a steering mode is a rear-wheel steer mode where the rear wheels are configured to turn, and the front wheels are not configured to turn. Another example of a steering mode is a crab steer mode where all of the wheels turn synchronously in the same direction. Yet another example of a steering mode is four wheel steering where the front wheels are angled in the opposite direction as the rear wheels which allows the shaker 200 to turn on a tight axis. Another example of a steering mode is an independent steer mode where the turning angle and direction of each wheel are independently configurable.

In some cases, the shaker 200 may include a controller to operate in a forward wheel steer mode regardless of the direction of travel. For example, the shaker 200 may be traveling in a first direction down a drive line where the first wheel 225-a is the forward wheel and the second and third wheels 225-b, 225-c are the rear wheels. In such a situation, the controller may cause the first wheel 225-a to steer the shaker 200 and the rear wheels 225-b, 225-c to have a fixed turning angle. If the shaker 200 changes its traveling direction without turning around and begins traveling in a second direction opposite the first direction down the same drive line, the controller may be configured to automatically modify the steering mode based on detecting the change in direction. Specifically, the controller may cause the second wheel 225-b and the third wheel 225-c (now the forward wheels) to steer the shaker 200 and the first wheel 225-a (now the rear wheel) to have a fixed and/or a variable turning angle.

FIG. 4 illustrates an example of a shaker 320 for harvesting tree nuts or tree fruit such as almonds in accordance with aspects of the present disclosure. For example, the shaker 320 may be an example of a shaker 200 as described with reference to FIG. 3. The shaker 320 may include a cab 325 coupled to the central beam 230 of the frame 205 using a coupling component 330. The cab 325 and the coupling component 330 may cooperate to allow the cab 325 to rotate relative to the frame 205 of the shaker 200. The shaker 320 may be an example of the shakers 15, 110, 120, and 200 described with reference to FIGS. 1-3. The cab 325 may be an example of the cab 210 described with reference to FIG. 3. The coupling component 330 may be an example of the coupling component 235 described with reference to FIG. 3.

The shaker head 220 may include a pair of pincers or jaws that are configured to clamp to a tree. The pair of pincers may be opened wide enough to receive a tree. Once the tree is positioned in the space 280 between the pincers, one or more of the pincers may be moved to touch the tree. Once the shaker head 220 is coupled with tree, the shaker head 220 may be actuated, thereby causing the tree to shake, and thereby causing fruits or nuts to fall from the tree.

In some examples, the coupling component 330 may be configured to allow the cab 325 to rotate relative to the frame 205. The coupling component 330 may be fixedly coupled with the central beam 230 of the frame 205 and may be rotationally coupled to a bottom wall 335 of the cab 325. The coupling component 330 may cantilever out away from central beam 230 and may be configured to support the weight of cab 325.

The walls of the cab 325 may be formed to allow the cab 325 to rotate without getting bound by the frame 205. To permit rotation a plurality of chamfer walls or chamfered walls 340 may be positioned between the front wall 285 and one or more of the side walls 290, 295. The chamfered wall 340 may be configured to round-off the corner between the front wall 285 and one or more side walls 290, 295. In some cases, the chamfered walls 340 may be examples of bevel walls or beveled walls.

The coupling component 330 may include a locking component to fix the cab 325 in a particular rotation position relative to the frame 205. Examples of the locking component may include a pin and latch to hold the cab to the frame or, the cab may be hydraulically actuated to rotate and/or hold its position relative to the frame.

When in the second configuration, an operator positioned in the cab 325 may have a line-of-sight out of a window or gap of the front wall 285 to the shaker heard 220. When the deflectors 215 are positioned on the shaker 320, the operator may be able to view tree and the shaker head 220 by looking under the deflectors 215 and through the notch 240 in the lower deflector. Also, when in the second configuration, an operator positioned in the cab 325 may have a line-of-sight in both directions of travel of the shaker 320 out of windows or gaps built into the side walls 290, 295. In some examples, the cab 325 may be fixed relative to the frame 205 (e.g., may not be rotatable).

In some examples, another deflector 275 may cover the shaker head 220 in order to catch falling fruit or nuts that fall onto the notch 240. The deflector 275 may be less slanted than the deflectors 215 or may be flat in order to accommodate a tree with a low crotch height. As the deflector 275 is relatively flat, in order to move fruit or nuts that fall onto the deflector 275 off of the deflector and onto the conveyer of a receiver, the shaker 320 may include one or more blowers 345 configured to blow air in the direction 350 to move fruit or nuts that fall onto the deflector 275 off of the deflector and onto the conveyer of a receiver.

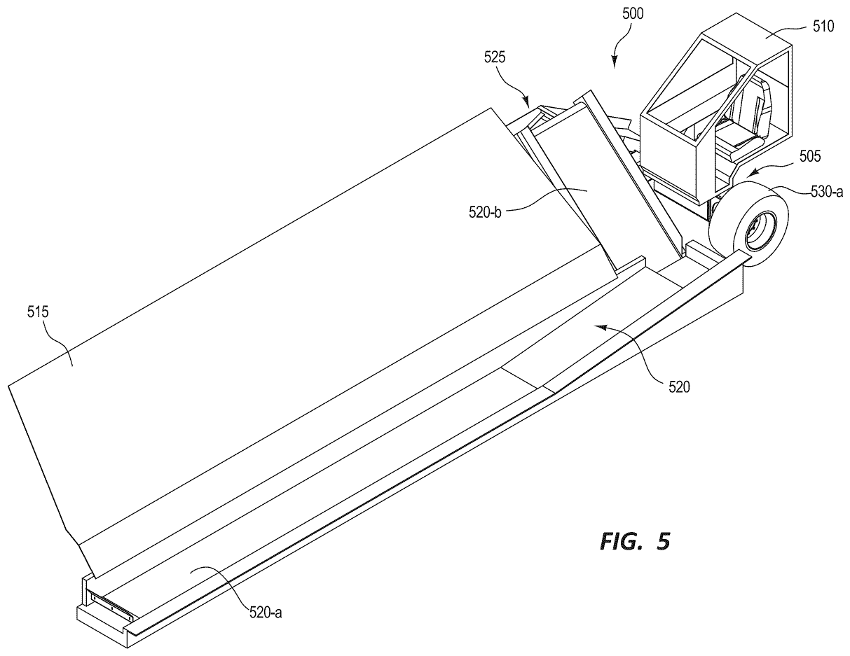

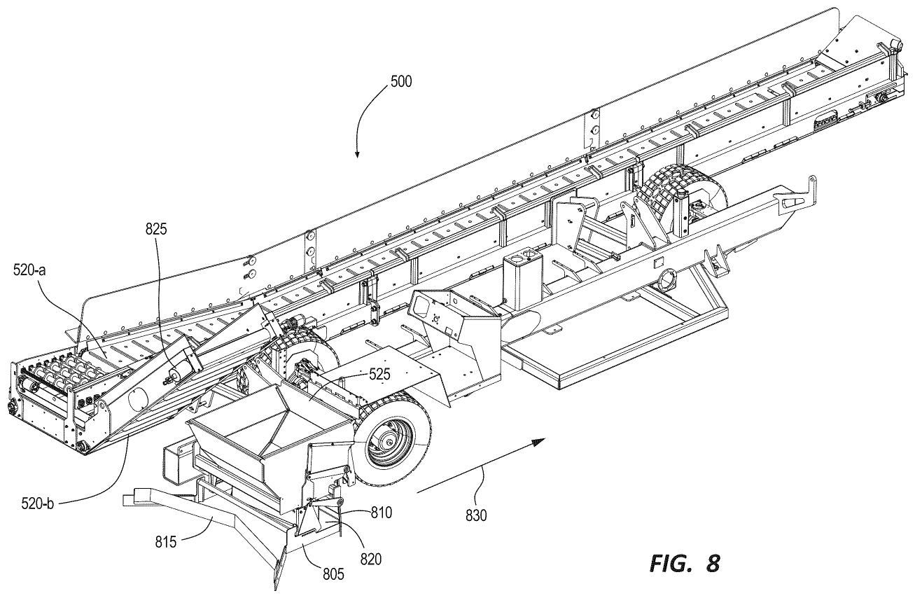

FIG. 5 illustrates an example of a receiver 500 for harvesting tree nuts or tree fruit such as almonds in accordance with aspects of the present disclosure. The receiver 500 may be an example of the receiver 20, the receiver 115, or the receiver 125 described with reference to FIGS. 1 and 2. The receiver 500 may be configured to collect falling fruits or nuts falling from a tree and deposit the nuts or fruit in a desired location such as the ground or a bin. The receiver 500 may include a frame 505, a cab 510, one or more deflectors 515, one or more conveyers 520, a hopper 525 (described in more detail with reference to FIGS. 8-10), and a plurality of wheels 530.

The frame 505 may be the main supporting structure of the receiver 500. The frame 505 may be configured to support mechanical components of the receiver 500 and to deal with static and dynamic loads, without undue deflection or distortion. The frame 505 may include one or more beams or rails.

The cab 510 may be moveably coupled with the frame 505. The cab 510 may be rotatable relative to the frame 505. The cab 510 may be configured to slide along the frame in a first direction perpendicular to the direction of travel of the receiver 500. In some cases, the cab 510 may be configured to raise and/or lower its position relative to the ground as well. Each of these abilities to move may be independently configurable thereby providing a plurality of cab positions and/or cab configurations. For example, the cab 510 may be moveable between a first position parallel to a first direction of travel of the receiver 500 and a second position perpendicular to the first direction of travel of the receiver 500. In some cases, the cab 510 may be positionable in more positions than the first position or the second position. The cab 510 may be positionable in a variety of different rotations and/or rotation angles relative to the frame 505. In some examples, the cab 510 may not be rotatable and/or positionable relative to the frame 505 (e.g., may be in a fixed position relative to the frame 505).

The one or more deflectors 515 of the receiver 500 may be configured to deflect falling objects (e.g., almonds) onto a conveyer 520 of the receiver 500. The deflectors 515 may be examples of the deflectors 30 described with reference to FIG. 1. The receiver 500 may include any number of deflectors 515 (e.g., one, two, three, four, five, six, seven, eight). In the illustrative example, the receiver 500 may include a single deflector. The deflector 515 may be repositionable. For example, deflector 515 may be configured to move up-and-down or laterally away from or toward the first conveyor 520-a. The deflectors 515 may be sized to extend beyond the dimensions of the canopy of the tree, at least the canopy of a first side of the tree. The deflectors 515 may be configured to be positionable based on the canopy of the tree being harvested. The deflectors 515 of the receiver 500 and the deflectors 215 of the shaker 200 may be used to intercept falling fruits or nuts from the same tree. For example, the deflectors 215 of the shaker 200 may be positioned under a first portion of the canopy of the tree being harvested and the deflectors 515 of the receiver 500 may be positioned under a second portion of the canopy of the tree being harvested. The deflectors 215, 515 may direct falling fruits or nuts into the conveyor 520 of the receiver 500. In some cases, the one or more deflectors 515 may be attached via a hinge to the conveyor 520. Both the one or more deflectors 515 and the conveyor 520 may be repositionable. In some cases, the repositioning may be performed concurrently or in unison. In some cases, the repositioning may be independent for each component (e.g., the repositioning of at least one deflector 515 may be independent of the conveyor 520). For example, the ‘rear’ of the deflector 515 (opposite side of conveyor) may be moved up and down and the ‘front’ of the deflector 515 may also be independently moved up and down. This allows an angle of the deflector 515 relative to the conveyor 520 to change and a height of the deflector 515 and the conveyor 520 to change.

The one or more conveyors 520 of the receiver 500 may be configured to collect the fruits or nuts deflected by the deflectors 515 of the receiver 500 and the deflectors 215 of the shaker 200. The one or more conveyors 520 may include first conveyor 520-a extending along the length of the receiver 500. The first conveyor 520-a may be positioned on the side of the receiver to be closest to the tree. The first conveyor 520-a may be configured as the collector point for the two-piece harvester. The first conveyor 520-a may be configured to move objects (e.g., fruits or nuts) to a second conveyor 520-b. The second conveyor 520-b may be configured to move the fruits or nuts up and over the receiver 500 to the far side of the receiver 500 to be deposited on the ground or in bins. The second conveyor 520-b may deposit fruits or nuts in the hopper 525. The one or more conveyors 520 may include one or more motors, rollers, and/or belts to move the fruits or nuts. The hopper 525 may be configured to control a rate of deposition of the fruits or nuts onto the ground. As described herein, in some examples, the receiver 500 may include a windrowing device that controls the size (e.g., height and width) of the windrow and prepares the ground prior to deposition of the crops via removing debris and/or flattening the ground when the receiver 500 is moved along the ground.

The receiver 500 may include a plurality of wheels 530. In the illustrative example, the receiver 500 includes three wheels, a first wheel 530-a rotating on a first axis of rotation, a second wheel 530-b rotating on a second axis of rotation different than the first axis of rotation, and a third wheel 530-c rotating along a third axis of rotation different than the first axis and the second axis. The wheels 530 may be coupled to the frame 505 using a plurality of components and/or linkages to allow each wheel to be controlled independently.

Each of the wheels 530 may be independently steerable. Meaning that the turning angle of each wheel 530 and/or the direction of travel of each wheel may be independently controlled. By having independent control of each wheel, the receiver 500 may be configured to operate using a plurality of steering modes. A steering mode may indicate a configuration of each wheel 530. A steering mode may indicate a turning angle of a wheel 530, whether a wheel is configured to change its turning angle or whether the turning angle is fixed, whether the turning angle of the wheel is tied to the turning angle of another wheel, a direction of rotation of wheel, whether the direction of rotation of the wheel is tied to the direction of rotation of another wheel, or a combination thereof. Examples of steering modes may include a forward-wheel steer mode, a rear-wheel steer mode, a crab steer mode, and an independent steer mode.

In some cases, the receiver 500 may include a controller to operate in a forward wheel steer mode regardless of the direction of travel. For example, the receiver 500 may be traveling in a first direction down a drive line where the first wheel 530-a is the forward wheel and the third wheel 530-c is the rear wheels. In such a situation, the controller may cause the first wheel 530-a to steer the receiver 500 and the third wheel 530-c to have a fixed turning angle. In some cases, the fixed turning angle may position the third wheel 530-c to be parallel to the frame. If the receiver 500 changes its traveling direction without turning around and begins traveling in a second direction opposite the first direction down the same drive line, the controller may be configured to automatically modify the steering mode. Specifically, the controller may cause the third wheel 530-c (now the forward wheel) to steer the receiver 500 and the first wheel 530-a (now the rear wheel) to have a fixed turning angle. The controller may also determine whether the second wheel 530-b acts as a steer wheel or as a fixed wheel in each of these situations.

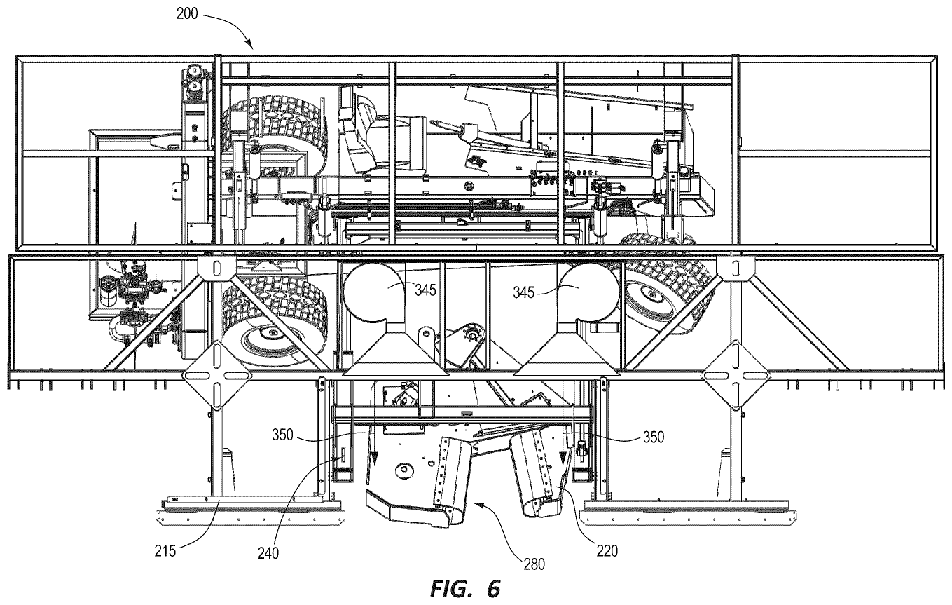

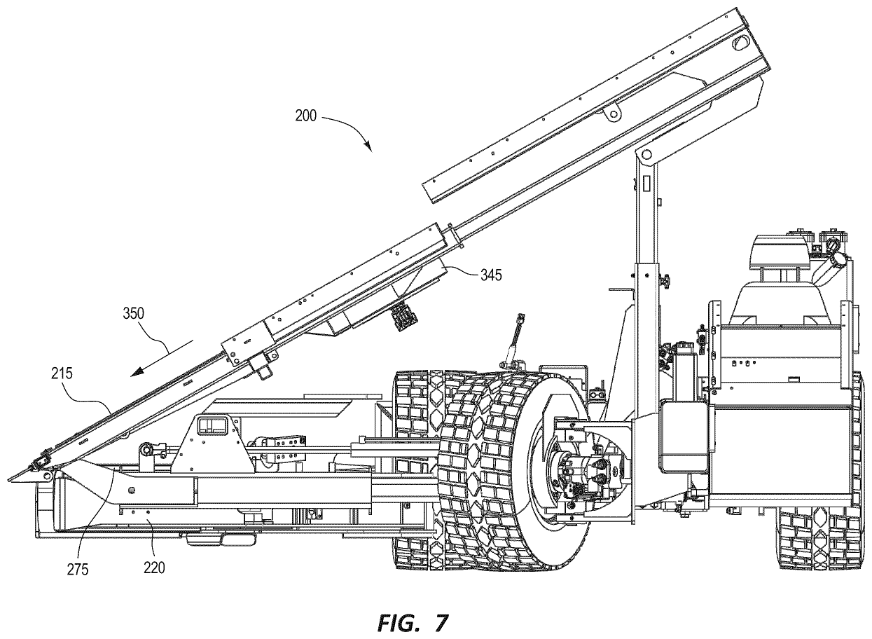

FIG. 6 illustrates a top view diagram of a shaker 200 of a harvester in accordance with aspects of the present disclosure. FIG. 7 illustrates a front view diagram of the shaker 200 of a harvester in accordance with aspects of the present disclosure. The shaker 200 of FIGS. 6 and 7 may be an example of the shakers 15, 110, 120, 200, and 320 described with reference to FIGS. 1-4.

As described herein, the shaker 200 may include a shaker head 220 that may include a pair of pincers or jaws that are configured to clamp to a tree. The pair of pincers may be opened wide enough to receive a tree. Once the tree is positioned in the space 280 between the pincers, one or more of the pincers may be moved to touch the tree. Once the shaker head 220 is coupled with tree, the shaker head 220 may be actuated, thereby causing the tree to shake, and thereby causing fruits or nuts to fall from the tree.

The shaker head 220 may be positioned in a notch within a deflector that is slanted with respect to the ground. As described herein, the shaker 200 may be configured to clamp onto a tree with a low crotch height. For example, the shaker 200 may be configured to clamp onto a tree with a crotch height of less than 25 inches from the ground. In order to catch nuts or fruit that fall above the notch 70, a deflector 275 that is less slanted or is flat with respect to the ground (e.g., is approximately parallel to the ground) may cover the notch 240. The shaker 200 may include one or more blowers 345 configured to blow air in the direction 350 to direct material, such as fruits or nuts that fall off of the tree, off of the deflector 275 and onto a conveyor of a receiver. In FIG. 6, some components of the shaker 200 (e.g., the deflector 275) are not shown in order to show other components that would be covered by those components. Similarly, in FIG. 7, some components of the shaker 200 are not shown in order to show other components that would be covered by those components.

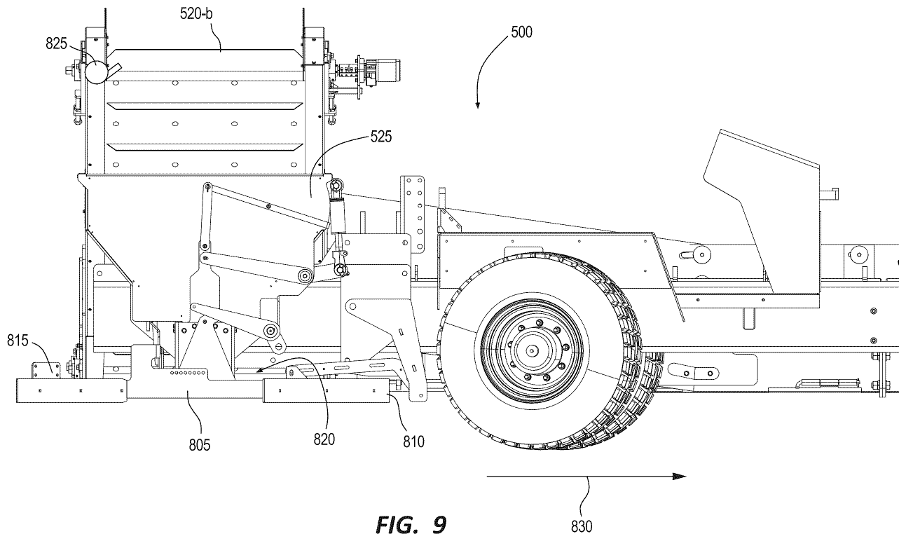

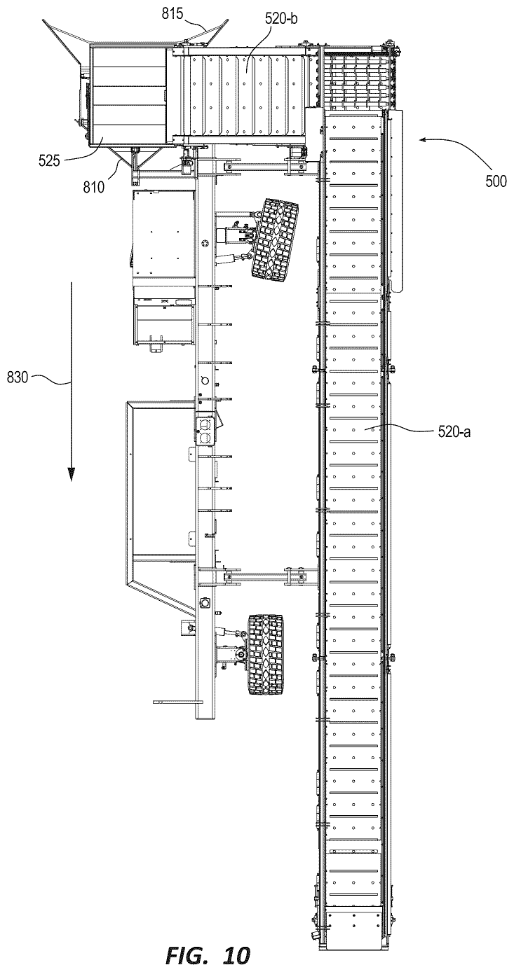

FIG. 8 illustrates an example isometric view diagram of a receiver 500 of a harvester that includes a hopper 525 and a windrowing device 805 in accordance with aspects of the present disclosure. FIG. 9 illustrates an example side view diagram of the receiver 500 of a harvester that includes the hopper 525 and the windrowing device 805 in accordance with aspects of the present disclosure. FIG. 10 illustrates an example top view diagram of the receiver 500 of a harvester that includes the hopper 525 and the windrowing device 805 in accordance with aspects of the present disclosure. The receiver 500 of FIGS. 8, 9, and 10 may be an example of the receiver 20, the receiver 115, the receiver 125, or the receiver 500 described with reference to FIGS. 1, 2, and 5.

As described herein, the material, including fruits or nuts, that falls from a tree in response to shaking of a tree may be directed by deflectors of the shaker and the receiver 500 onto a conveyor (e.g., a first conveyor 520-a). The first conveyor 520-a may direct the material toward a second conveyor 520-b, which may deposit the material into a hopper 525. The receiver 500 may include one or more blowers 825 that blow air through the material as the material is being deposited from the second conveyor 520-b. Debris such as leaves may be lighter than the fruits or nuts, and thus may be removed from the fruits or nuts via the blowing of air through the material. Accordingly, use of the blower(s) 825 may reduce the amount of debris that is deposited into the hopper 525 from the second conveyor 520-b.

The hopper 525 may control a rate of deposition of fruits or nuts onto the ground. The hopper 525 may deposit the fruits or nuts onto the ground within an interior portion 820 of a windrowing device 805. The windrowing device 805 may include a first cross component 810 and a second cross component 815. The first cross component 810 may prepare the ground for deposition of a windrow. For example, during movement of the receiver 500 in the direction 830, the windrowing device 805 may remove debris from and flatten the ground in front of the interior portion 820 of the windrowing device 805. To remove debris from the path of the windrow, the first cross component 810 may be V shaped. The sidewalls of the windrowing device and the first cross component 810 may touch the ground when in operation (e.g., during movement of the receiver in the direction 830). A height of the second cross component 815 may be adjustable with respect to the sidewalls of the windrowing device 805 and accordingly with respect to the ground in order to control or adjust an amount of fruits or nuts in the windrow (e.g., to control or adjust a height of the windrow). A height of the windrow may refer to a depth of the fruits or nuts above the ground.

In FIG. 8, some components of the receiver 500 are not shown in order to show other components that would be covered by those components. Similarly, in FIG. 9, some components (e.g., the conveyor 520-a and the deflector 515) of the receiver 500 are not shown in order to show other components that would be covered by those components. Similarly, in FIG. 9, some components (e.g., the conveyor 520-a and the deflector 515) of the receiver 500 are not shown in order to show other components that would be covered by those components. Similarly, in FIG. 9, some components (e.g., the deflector 515) of the receiver 500 are not shown in order to show other components that would be covered by those components.

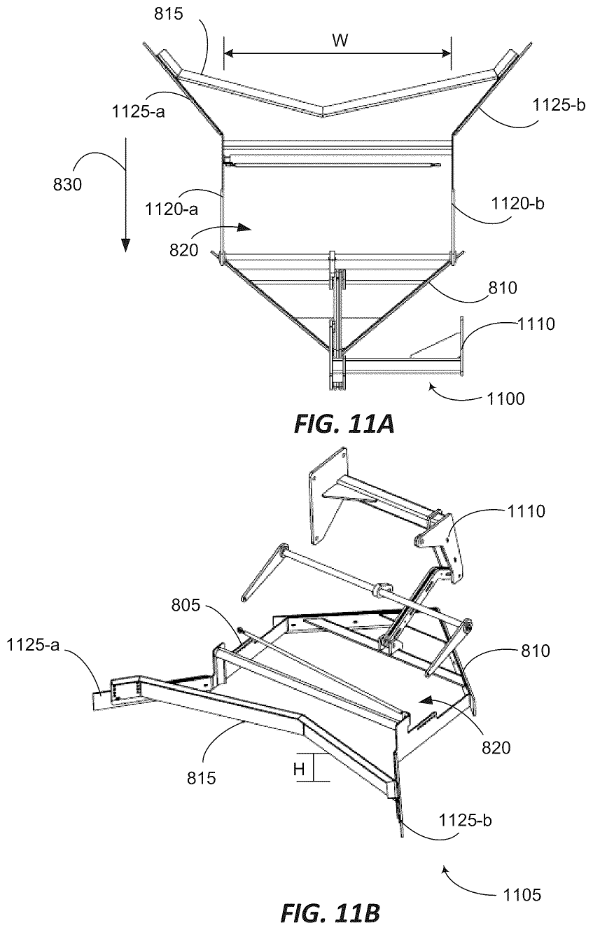

FIG. 11A illustrates an example top view diagram 1100 and FIG. 11B illustrates an example isometric view diagram 1105 of a windrowing device 805 in accordance with aspects of the present disclosure. The windrowing device 805 may be the windrowing device 805 of FIGS. 8, 9, and 10.

The windrowing device 805 may receive fruits or nuts deposited from a hopper in an interior portion 820 of the windrowing device 805. The interior portion 820 may be formed by a first cross component 810, a second cross component 815, and sidewalls 1120 (e.g., a first sidewall 1120-a and a second sidewall 1120-b). The windrowing device 805 may include an attachment component 1110 that connects the windrowing device 805 with the body of the receiver 500.

As shown, the first cross component has a V shape that may prepare the ground by removing debris and flattening the ground in the path of the windrow via movement in the direction 830. A height H of the second cross component 815 with respect to the ground may be adjustable in order to control a height of the windrow. In some examples, a width W of the interior portion 820 of the windrowing device 805 may be adjustable (e.g., the width W between the first sidewall 1120-a and the second sidewall 1120-b may be adjustable) to control a width of the windrow. Adjusting the height or width of the windrow adjusts the amount of fruits or nuts in a cross section of the windrow. In some examples, an angle between a first flange 1125-a and the first sidewall 1120-a and/or an angle between a second flange 1125-b and the second sidewall 1120-b may be adjustable to control a width of the windrow.

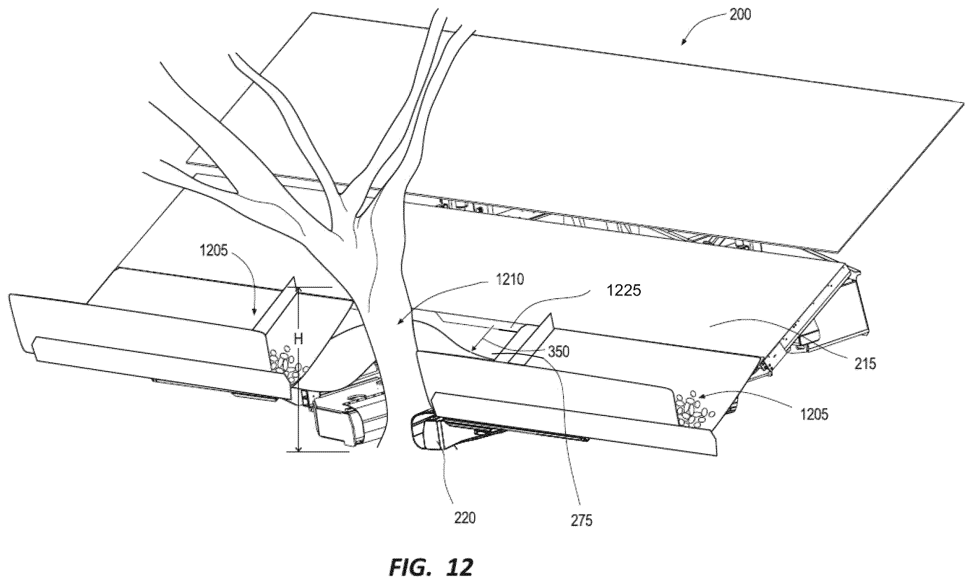

FIG. 12 illustrates an example a perspective view of a shaker 200 of a harvester coupled with a tree in accordance with aspects of the present disclosure. The shaker 200 of FIG. 12 may be an example of the shakers 15, 110, 120, 200, and 320 described with reference to FIGS. 1-4, 6, and 7.

As described herein, the shaker 200 may include a shaker head 220 that may include a pair of pincers or jaws that are clamped to a trunk 1210 of a tree. The crotch height H of the tree (e.g., the height between the ground and the lowest branch that offshoots from the trunk 1210) may be less than 25 inches. Accordingly, the shaker 200 may include a deflector 275 positioned within a notch within the slanted deflector 215. The deflector 275 covers the shaker head 220.

Once the shaker head 220 is coupled with tree, the shaker head 220 may be actuated, thereby causing the tree to shake, and thereby causing fruits or nuts 1205 to fall from the tree. Fruits or nuts 1205 that fall from the tree onto the deflector 215 are directed via gravity to the bottom of the deflector 215 and onto a conveyor of a receiver side of the harvester. As the deflector 275 is relatively flat with respect to the ground, gravity may not direct fruits or nuts 1205 that fall from the tree onto the deflector 275 onto the conveyor of a receiver side of the harvester. Thus, as described with reference to FIGS. 4 and 6-7, the shaker 200 may include one or more blowers 345 to blow air through slots 1225 in the direction 350 to direct fruits or nuts 1205 that fall from the tree onto the deflector 275 onto the conveyor of a receiver side of the harvester.

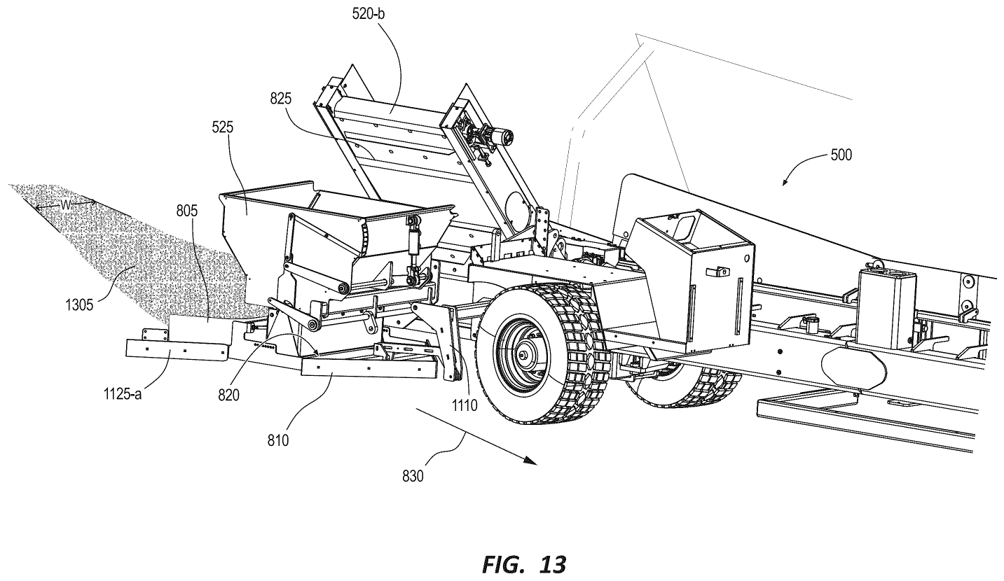

FIG. 13 illustrates an example isometric view of receiver 500 of a harvester that includes a hopper and windrowing device in accordance with aspects of the present disclosure. The receiver 500 of FIG. 13 may be an example of the receiver 20, the receiver 115, the receiver 125, or the receiver 500 described with reference to FIGS. 1, 2, 5, and 8-10.

As described herein, the material, including fruits or nuts, that falls from a tree in response to shaking of a tree may be directed by deflectors of the shaker and the receiver 500 onto a conveyor (e.g., a first conveyor 520-a as shown in FIGS. 5 and 8-10). The first conveyor 520-a may direct the material toward a second conveyor 520-b, which may deposit the material into a hopper 525. The receiver 500 may include one or more blowers 825 that blow air through the material as the material is being deposited from the second conveyor 520-b. Debris such as leaves may be lighter than the fruits or nuts, and thus may be removed from the fruits or nuts. Accordingly, use of the blower(s) 825 may reduce the amount of debris that is deposited into the hopper 525 from the second conveyor 520-b.

The hopper 525 may control a rate of deposition of fruits or nuts onto the ground. The hopper 525 may deposit the fruits or nuts onto the ground within an interior portion 820 of a windrowing device 805. The windrowing device may include a first cross component 810 and a second cross component 815. The first cross component 810 may prepare the ground for deposition of a windrow 1305. For example, during movement of the receiver 500 in the direction 830, the windrowing device 805 may remove debris from and flatten the ground in front of the interior portion 820 of the windrowing device 805. To remove debris from the path of the windrow, the first cross component 810 may be V shaped. A height of the second cross component may be adjustable in order to control or adjust an amount of fruits or nuts in the windrow 1305 (e.g., to control or adjust a height of the windrow). In some examples, a width the interior portion 820 of the windrowing device 805 may be adjustable and/or an angle of flanges 1125 with respect to sidewalls 1120 of the windrowing device 805 may be adjustable to control a width W of the windrow 1305.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration. An operating system utilized by the processor (or by I/O controller module or another module described above) may be iOS®, ANDROID®, MS-DOS®, MS-WINDOWS®, OS/2®, UNIX®, LINUX®, or another known operating system.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

This description, for purposes of explanation, has been described with reference to specific examples. The illustrative discussions above, however, are not intended to be exhaustive or limit the present systems and methods to the precise forms discussed. Many modifications and variations are possible in view of the above teachings. The examples were chosen and described in order to explain the principles of the present systems and methods and their practical applications, to enable others skilled in the art to utilize the present systems, apparatus, and methods and various examples with various modifications as may be suited to the particular use contemplated.

What is claimed is:

1. A system, comprising:
a shaker, comprising:
a shaker head configured to engage a trunk of a tree to shake the tree;
a first deflector configured to direct fruits or nuts falling from the tree in response to a shaking of the tree, the first deflector being slanted with respect to ground, and the first deflector having a notch to receive the tree;
a second deflector within the notch and at least partially covering the shaker head, the second deflector approximately parallel to the ground; and
a blower configured to blow air to direct the fruits or nuts falling from the tree off of the second deflector in response to the shaking of the tree; and
a receiver, comprising:
a hopper; and
a conveyor configured to receive the fruits or nuts directed from the first deflector and the second deflector and deposit the fruits or nuts into the hopper, wherein the hopper is at an end of the conveyor, wherein the hopper is configured to deposit the fruits or nuts on the ground, and wherein the blower is configured to blow air toward the conveyor.

2. The system of claim 1, further comprising:
a second blower configured to blow air to remove debris from the fruits or nuts during deposition of the fruits or nuts from the conveyor into the hopper.

3. The system of claim 1, wherein the hopper is configured to:
control a rate of deposition of the fruits or nuts on the ground.

4. The system of claim 1, further comprising:
a windrowing device coupled with the hopper and configured to perform ground preparation and receive the fruits or nuts deposited from the hopper and distribute the fruits or nuts in a windrow when the hopper and the windrowing device are moved along the ground.

5. The system of claim 4, wherein, to perform ground preparation, the windrowing device comprises a first component configured to clear debris and flatten a portion of the ground via movement of the first component across the portion of the ground prior to creation of the windrow on the portion of the ground.

6. The system of claim 5, wherein the windrowing device comprises a second component that trails the first component during movement of the hopper and the windrowing device along the ground, wherein a height of the second component is adjustable to control a height of the windrow.

7. The system of claim 4, wherein the windrowing device comprises a width adjustment mechanism to control a width of the windrow.

8. The system of claim 1, wherein a top of the shaker head is less than or equal to 25 inches from the ground when coupled with the tree.

9. The system of claim 1, wherein the receiver comprises a third deflector configured to direct the fruits or nuts falling from the tree in response to the shaking of the tree, the third deflector being slanted with respect to the ground, wherein the conveyor is further configured to receive the fruits or nuts directed from the third deflector.

10. The system of claim 9, wherein the shaker comprises a fourth deflector positioned above the first deflector and configured to direct the fruits or nuts falling from the tree onto the first deflector in response to the shaking of the tree, and wherein the receiver comprises a fifth deflector positioned above the third deflector and configured to direct the fruits or nuts falling from the tree onto the third deflector in response to the shaking of the tree.

11. The system of claim 1, wherein the shaker comprises a first plurality of wheels and is configured to travel in a first direction and in a second direction opposite the first direction, and wherein the receiver comprises a second plurality of wheels and is configured to travel in the first direction and in the second direction opposite the first direction independently of the shaker.

12. The system of claim 9, wherein the shaker and the receiver are configured to collect the fruits or nuts that fall from the tree shaken by the shaker.

13. A shaker device comprising:
a shaker head configured to engage a trunk of a tree to shake the tree;
a first deflector configured to direct fruits or nuts falling from the tree in response to a shaking of the tree, the first deflector being slanted with respect to ground, and the first deflector having a notch to receive the tree;
a second deflector within the notch and at least partially covering the shaker head, the second deflector approximately parallel to the ground; and
a blower configured to blow air to direct the fruits or nuts falling from the tree off of the second deflector in response to the shaking of the tree.

14. The shaker device of claim 13, wherein a top of the shaker head is less than or equal to 25 inches from the ground when coupled with the tree.

15. The shaker device of claim 13, further comprising:
a third deflector positioned above the first deflector and configured to direct fruits or nuts falling from the tree onto the first deflector in response to the shaking of the tree.

16. A receiver device, comprising:
a first deflector configured to direct fruits or nuts falling from a tree in response to a shaking of the tree, the first deflector slanted with respect to ground;
a hopper; and
a conveyor configured to receive the fruits or nuts directed from the first deflector and from a second deflector of a shaker device and deposit the fruits or nuts into the hopper, wherein the hopper is configured to deposit the fruits or nuts on the ground, and wherein the hopper is configured to control a rate of deposition of the fruits or nuts on the ground.

17. The receiver device of claim 16, further comprising:
a windrowing device coupled with the hopper and configured to perform ground preparation and receive the fruits or nuts deposited from the hopper and distribute the fruits or nuts in a windrow when the hopper and the windrowing device are moved along the ground.

18. The receiver device of claim 17, wherein, to perform ground preparation, the windrowing device comprises a first component configured to clear debris and flatten a portion of the ground via movement of the first component across the portion of the ground prior to creation of the windrow on the portion of the ground.

19. The receiver device of claim 18, wherein the windrowing device comprises a second component that trails the first component during movement of the hopper and the windrowing device along the ground, wherein a height of the second component is adjustable to control a height of the windrow, and wherein the windrowing device comprises a width adjustment mechanism to control a width of the windrow.

20. The receiver device of claim 16, further comprising:
a blower configured to blow air to remove debris from the fruits or nuts during deposition of the fruits or nuts from the conveyor into the hopper; and
a third deflector positioned above the first deflector and configured to direct fruits or nuts falling from the tree onto the first deflector in response to the shaking of the tree.
